(19) United States
(12) Patent Application Publication
(10) Pub. No.: US 2019/0120189 A1
(43) Pub. Date: Apr. 25, 2019

(54) SOLENOID VALVE FOR CONTROLLING FLUIDS

(71) Applicant: Robert Bosch GmbH, Stuttgart (DE)

(72) Inventors: Nico Herrmann, Karlsruhe (DE); Sebastian Wansleben, Kornwestheim (DE)

(21) Appl. No.: 16/131,282

(22) Filed: Sep. 14, 2018

(30) Foreign Application Priority Data
Oct. 20, 2017 (DE) 102017218764.6

(51) Int. Cl. F02M 51/06; F02M 63/00

(52) U.S. Cl. CPC F02M 51/0664; F02M 63/0075; F02M 63/0021

(57) ABSTRACT

A solenoid valve for controlling fluids, in particular, a fuel injection solenoid valve. The solenoid valve includes a valve member for opening or closing an opening, an armature for actuating the valve member, and an armature stop, via which a movement of the armature is delimitable. The armature includes an armature base body having a first armature lining, which is situated on the armature base body and which exhibits a lower hardness than the armature stop. Alternatively, the armature stop includes a stop base body having a first stop lining, which is situated on the stop base body and which exhibits a lower hardness than the armature. This makes it possible to dampen a movement of the armature.

### CROSS REFERENCE

The present application claims the benefit under 35 U.S.C. § 119 of German Patent No. DE 102017218764.6 filed on Oct. 20, 2017, which is expressly incorporated herein by reference in its entirety.

### FIELD

The present invention relates to a solenoid valve for controlling fluids, in particular, a fuel injection solenoid valve.

### BACKGROUND INFORMATION

In solenoid valves, an armature for controlling a valve member, for example, a needle, is provided. In such case, the armature is usually not fixedly connected to the valve member, but is mounted in cantilever fashion between two stops. An axial play is provided between the armature and the two stops, which is referred to as armature free path. A compression spring ensures that, depending on the design of the solenoid valve (opening outwardly or opening inwardly), the armature invariably abuts one of the stops in the idle state and thus has the complete armature free path as an “acceleration distance” available to it when the solenoid valve is activated. When the solenoid valve closes, the armature is able to bounce back again after striking the corresponding stop. In the process, it may occur that the entire armature free path is passed through once again and that the armature still possesses so much energy when it strikes the other stop again that the valve member is once again briefly lifted from the valve seat. This results in an undesirable post-injection, which in a vehicle results in increased pollutant emissions and an increased consumption. Even when the armature, when bouncing back, does not travel through the entire armature free path, the armature requires some time until it comes to rest. If the solenoid valve is activated again before the armature finally comes to rest, (for example, in the case of multiple injection with short pause intervals between multiple injections), the resulting armature movement is a function of the position and the velocity vector of the armature at the point in time of the activation. As a result, a robust valve function in the situation described above cannot be ensured. In the worst case, the solenoid valve does not open, since the impact pulse is insufficient to overcome the closing forces. A certain wear develops on the stops of the armature over the service life of the solenoid valve. As a result of the hammering contact, the surfaces of the armature and of the armature stop become aligned at the contact points in such a way that a smoothing or interlinking occurs. This process takes place mainly in the first 50 million to 100 million load changes (approximately 500 million to 1 billion load changes over the entire operating time). This results in a change in the valve behavior due to increasing hydraulic damping at the stops. The increasing hydraulic damping has a positive or negative effect depending on the function considered. The increased damping results in a more rapid subsiding of the armature movement after the solenoid valve closes, which has a positive effect on the pause times achievable between each injection. The altered damping also causes a shift in the characteristic curve as a result of an altered opening and closing behavior, which may lead to significant problems, primarily in the metering of small quantities. Here, deviations of up to 100% may occur compared to the new condition.

### SUMMARY

An example solenoid valve according to the present invention for controlling fluids includes a valve member for opening or closing an opening, an armature for actuating the valve member and an armature stop via which a movement of the armature is delimitable. The armature includes an armature base body having a first armature lining, which is situated on the armature base body and which exhibits a lower hardness than the armature stop. Alternatively, the armature stop includes a stop base body having a first stop lining, which is situated on the stop base body and which exhibits a lower hardness than the armature. A movement of the armature is dampable as a result of the provision of the first armature lining or of the first stop lining. Thus, the first armature lining or the first stop lining may be understood to be a damping device within the scope of the present invention. The increased damping of the armature movement results in a reduction of armature bounces. A more rapid alignment of the contact surfaces of the armature stop and of the armature within fewer load changes results in an increased hydraulic damping and, therefore, in a reduction of the armature movement after the opening of the solenoid valve is closed. An additional advantage is the maintenance of the characteristic curve of the solenoid valve over its service life. In addition, wear is anticipated within a few load cycles. Therefore, important parameters such as, for example, the characteristic curve, the dead time and closing times of the solenoid valve, change only marginally over the service life. The solenoid valve may be used as an injection valve, where a fluid may be injected when the opening is opened. The solenoid valve is, in particular, a fuel injection solenoid valve, particularly preferred, a gasoline high-pressure injection valve. The operating principle of a hydraulic damping is based in general on the displacement of a fluid from a gap between two surfaces. In this operation, fluid may be displaced during the operation of the solenoid valve from the space or gap between opposing surfaces of the armature and of the armature stop. If the armature and the armature stop move toward one another, fluid situated between these components is forced from the gap, which results in an increased pressure in the gap. The greater the fluid friction and the smaller the gap are, the greater the resulting pressure becomes. Conversely, a negative pressure forms in the gap when the components move apart. As a result, a force acts on the armature, which is directed counter to its movement and therefore has a damping effect. If, in general, a harder surface strikes a softer surface, the harder surface profile is reflected in the soft surface. This creates an interlinking of the surfaces, in which the existing cavities are filled in. This may create a high hydraulic damping, since the effective flow cross section in the gap between the armature and the armature stop is significantly reduced. The first armature lining or the first stop lining in this case serves as a “sacrificial layer,” which no longer accepts any bearing ratios with increasing operating time and serves instead as a filler between the roughness peaks of the harder armature base body or of the harder stop base body. In time, the armature base body and the stop base body also wear out and become aligned. Until this alignment is completed, the first armature lining or the first stop lining fills the interspaces. Thus, a high damping may be advantageously ensured from the outset, which is changed only marginally over the operating time. The dead time corresponds to the time that passes after the solenoid valve is activated, until the solenoid valve opens.

Preferred refinements of the present invention are described herein.

The first armature lining or the first stop lining is preferably metallic. Alternatively, the first armature lining or the first stop lining may not be metallic. The first armature lining or the first stop lining is formed preferably of ceramic or plastic.

A second armature lining, which exhibits a greater hardness than the first armature lining, is preferably situated on the armature between the armature base body and the first armature lining. Alternatively, a second stop lining that exhibits a greater hardness than the first stop lining is preferably situated on the armature stop between the stop base body and the first stop lining. Thus, the armature base body may be protected against wear by the second armature lining or the stop base body may be protected against wear by the second stop lining.

According to one preferred embodiment, the armature stop includes a stop base body having a stop lining that exhibits a greater hardness than the first armature lining. Alternatively, the armature preferably includes an armature base body having an armature lining that exhibits a greater hardness than the first stop lining.

A thickness of the first armature lining less than 80% of the height of a maximum roughness peak of the second armature lining is also preferred, the height of the maximum roughness peak being measured from a center line of a roughness profile of the second armature lining. In the event that only the first armature lining is provided, a thickness of the first armature lining less than 80% of a height of a maximum roughness peak of the armature base body is preferred, the height of the maximum roughness peak being measured from a center line of a roughness profile of the armature base body.

Alternatively, a thickness of the first stop lining less than 80% of a height of a maximum roughness peak of the second stop lining is preferred, the height of the maximum roughness peak being measured from a center line of a roughness profile of the second stop lining. In the event that only the first stop lining is provided, a thickness of the first stop lining less than 80% of a height of a maximum roughness peak of the stop base body is preferred, the height of the maximum rough peak being measured from a center line of a roughness profile of the stop base body.

In addition to the first armature lining or to the first stop lining, each of which, as already described, is equivalent to a damping device, an additional, separate damping device may be provided in the solenoid valve. The separate damping device is configured in this case to dampen the movement of the armature. Thus, the damping of the movement of the armature is reinforced by the separate damping device.

If the armature is provided with the first armature lining and/or with the second armature lining, a hardness of the first armature lining is advantageously less than 100 HV, preferably less than 150 HV, particularly preferably less than 200 HV, and/or a hardness of the second armature lining is greater than 800 HV, preferably greater than 900 HV, particularly preferably greater than 1000 HV. According to one preferred embodiment of the present invention, a hardness of the first armature lining is less than 200 HV and a hardness of the second armature lining is greater than 1000 HV.

If the armature stop is provided with the first stop lining and/or with the second stop lining, a hardness of the first armature lining is less than 100 HV, preferably less than 150 HV, particularly preferably less than 200 HV, and/or a hardness of the second stop lining is greater than 800 HV, preferably greater than 900 HV, particularly preferably greater than 1000 HV. According to one preferred embodiment of the present invention, a hardness of the first stop lining is less than 200 HV and a hardness of the second stop lining is greater than 1000 HV.

Another aspect of the present invention relates to an internal combustion engine that includes a previously described solenoid valve.

The present invention also relates to a vehicle, which includes a previously described internal combustion engine.

### BRIEF DESCRIPTION OF THE DRAWINGS

Preferred exemplary embodiments of the present invention are described in detail below with reference to the figures, identical or functionally identical components being provided in each case with the same reference numeral.

FIG. 1 schematically shows a sectional view of a solenoid valve according to a first exemplary embodiment of the present invention.

FIG. 2 shows an enlarged representation of an area of the solenoid valve shown in FIG. 1.

FIG. 3 schematically shows a sectional view of a solenoid valve according to a second exemplary embodiment of the present invention.

FIG. 4 schematically shows a sectional view of a solenoid valve according to a third exemplary embodiment of the present invention.

FIG. 5 schematically shows a sectional view of a solenoid valve according to a fourth exemplary embodiment of the present invention.

FIG. 6 schematically shows a sectional view of a solenoid valve according to a fifth exemplary embodiment of the present invention.

FIG. 7 shows an enlarged representation of an area of the solenoid valve shown in FIG. 6.

FIG. 8 schematically shows a sectional view of a solenoid valve according to a sixth exemplary embodiment of the present invention.

FIG. 9 schematically shows a sectional view of a solenoid valve according to a seventh exemplary embodiment of the present invention.

FIG. 10 schematically shows a sectional view of a solenoid valve according to an eighth exemplary embodiment of the present invention.

### DETAILED DESCRIPTION OF EXAMPLE EMBODIMENTS

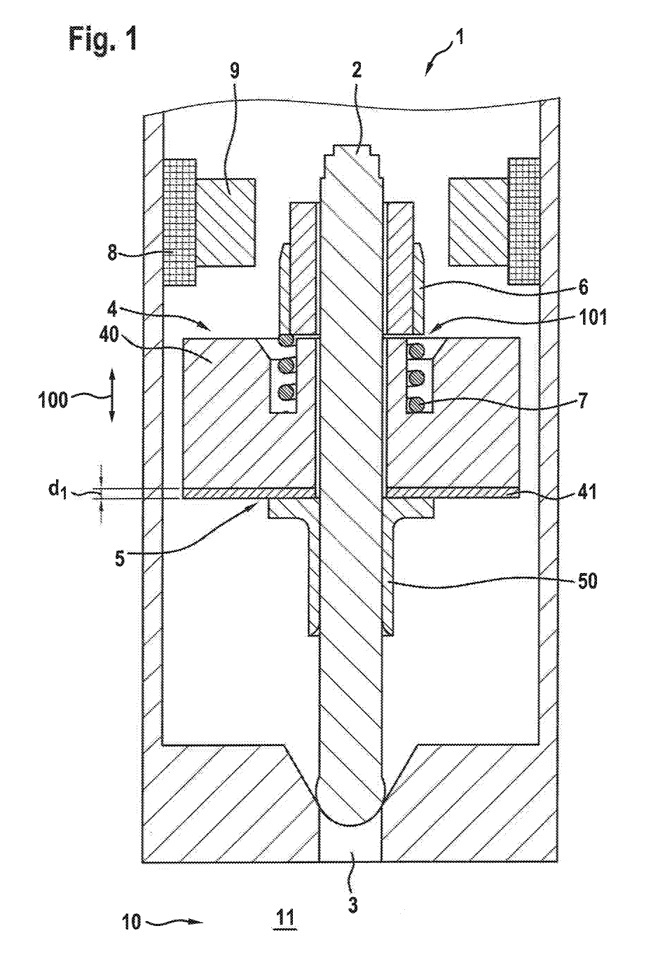

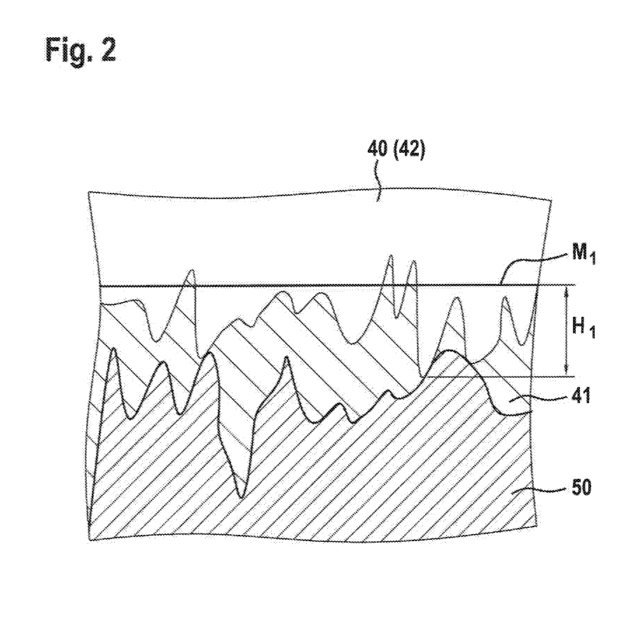

A solenoid valve 1 for controlling fluids according to a first exemplary embodiment of the present invention is described in detail below with reference to the FIGS. 1 and 2.

Solenoid valve 1 is designed as an injection valve. Solenoid valve 1 is, in particular, a fuel injection solenoid valve, particularly preferably a gasoline high-pressure injection valve. Solenoid valve 1 is configured to inject fuel into a combustion chamber 11 of an internal combustion engine 10.

As is apparent from FIG. 1, solenoid valve 1 includes a valve member 2 for opening or closing an opening 3, an armature 4 for actuating valve member 2, and an armature stop 5, via which a movement of armature 4 is delimitable. In this exemplary embodiment, solenoid valve 1 is designed as an inwardly opening valve. This means that opening 3 is opened when valve member 2 is moved in the direction toward the interior of solenoid valve 1. In addition, armature stop 5 is situated in such a way that the movement of armature 4 is delimited during the closing process.

Valve member 2 is designed as a needle and is not fixedly connected to armature 4. Armature 4 is mounted in a cantilever fashion between armature stop 5 and an additional armature stop 6. Armature stop 5 is designed, in particular, as a stop sleeve mounted on valve member 2. Additional armature stop 6 is formed preferably as a stop ring, which is fastened to valve member 2. In addition, armature stop 5 faces combustion chamber 11 of internal combustion chamber 10, the additional armature stop 6 facing a rail or distributor of the internal combustion engine. A solenoid coil 8 and an internal pole 9 are preferably provided for moving armature 4. As solenoid coil 8 is energized, solenoid coil 8 draws armature 4 in the direction of internal pole 9.

Valve member 2 is actuated via the contacting of armature 4 with additional armature stop 6, which results in the opening of solenoid valve 1 as solenoid valve 1 opens inwardly.

The above described arrangement of valve member 2 and of armature 4 in relation to one another has the advantage that valve member 2 may be reliably opened even under greater fuel pressures with the same magnetic force via a resulting impulse of armature 4 during opening. This is referred to as mechanical boostering. In addition, a decoupling of the bodies of valve member 2 and of armature 4 is effectuated, as a result of which the impact forces are divided among two impulses in the valve seat of solenoid valve 1. This may reduce wear of the valve seat. The decoupling of the bodies of valve member 2 and of armature 4 also results in a lower bounce tendency in highly dynamic injection valves.

A spring element 7 is also provided in solenoid valve 1. Spring element 7 is configured in such a way that in an idle state of armature 4, armature 4 abuts armature stop 5. In this exemplary embodiment, spring element 7 is a compression spring that exerts a force on valve member 2 in the direction of armature stop 5 or in a closing direction of solenoid valve 1.

Armature stop 5 may be understood to be a first armature stop and additional armature stop 6 may be understood to be a second armature stop within the scope of the present invention.

An axial play 101 is provided between armature 4 and the two armature stops 5, 6, which is referred to as an armature free path. In FIG. 1, solenoid valve 1 is depicted in the closed state, in which armature 4 abuts armature stop 5. In this state, therefore, axial play 101 corresponds to a gap between armature 4 and additional armature stop 6. The closed state corresponds to the idle state of armature 4. When armature 4 abuts additional armature stop 6, which is the case in the open state of solenoid valve 1, axial play 101 corresponds to a gap between armature 4 and additional armature stop 6. In a state between the closed state and the open state, axial play 101 corresponds to the combination of the gap present at this point in time between armature 4 and armature stop 5 and to the gap present at this point in time between armature 4 and additional armature stop 6.

Armature 4 includes an armature base body 40 having a first armature lining 41, armature stop 5 including a stop base body 50. In this configuration, first armature lining 41 is situated directly on armature base body 40 and has a lower hardness than armature stop 5, and armature base body 50. Armature stop 5 does not include a lining in this exemplary embodiment.

Armature 4 and armature stop 5 are contactable via first armature lining 41. This means that the hardness of first armature lining 41 is less than the hardness of the portion of armature stop 5, with which first armature lining 41 is contactable.

First armature lining 41 is, in particular, metallic. Alternatively, first armature lining 41 may be ceramic or made of plastic.

In addition, a hardness of first armature lining 41 is less than 100 HV, preferably less than 150 HV, particularly preferably less than 200 HV.

FIG. 2 is an enlarged representation of an area of solenoid valve 1 shown in FIG. 1. It is apparent from FIG. 2 that the harder profile of stop body 50 is formed essentially in the softer profile of first armature lining 41. Thus, the interlinking between armature base body 40 and stop base body 50 is achieved by the filling in of cavities via first armature lining 41.

In addition, a thickness d1 (FIG. 1) of first armature lining 41 is less than 80% of a height H1 of a maximum roughness peak of armature base body 40, height H1 of the maximum roughness peak being measured from a center line M1 of a roughness profile of armature base body 40 (FIG. 2).

Significant advantages result from the above described structure of armature 4 as well as of armature stop 5. Thus, the contacting surfaces of armature 4 and of armature stop 5 (i.e., first armature lining 41 and stop base body 50) become quickly aligned within the first thousand load changes, which results in excellent damping properties. At the same time, underlying armature base body 40 of armature 4 ensures wear protection, which protects armature 4 over the operating time. Thus, the change of the hydraulic damping takes place immediately at the outset of the operating time, which may also begin at the factory. A consistent behavior of solenoid valve 1 may thus also be guaranteed over long operating times. An undesirable post-injection due to a bounce-back of armature 4 against armature stop 5, in particular, is avoided.

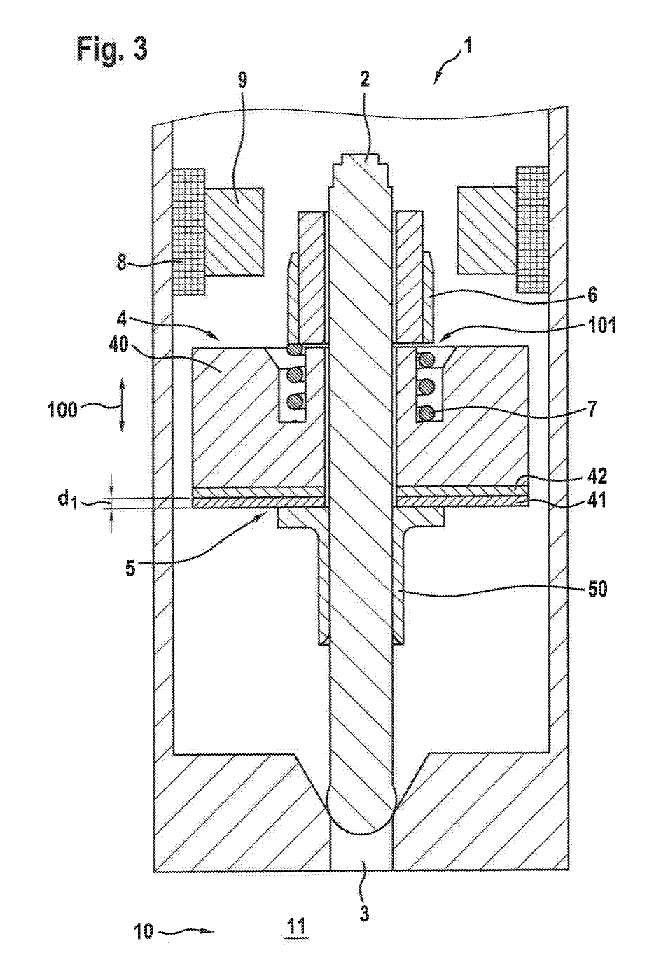

FIG. 3 shows a solenoid valve 1 for controlling fluids according to a second exemplary embodiment of the present invention.

Here, armature 4 includes a second armature lining 42 as compared to the first exemplary embodiment, which is situated between armature base body 40 and first armature lining 41. Second armature lining 42 exhibits a greater hardness than first armature lining 41.

Thickness d3 (FIG. 3) of first armature lining 41 is less than 80% of a height H1 of a maximum roughness peak of second armature lining 42, height H1 of the maximum roughness peak being measured from a center line M1 of a roughness profile of second armature lining 42 (reference numeral 42 placed in parentheses in FIG. 2).

In addition, a hardness of first armature lining 41 is less than 100 HV, preferably less than 150 HV, particularly preferably less than 200 HV and/or a hardness of second armature lining 42 is greater than 800 HV, preferably greater than 900 HV, particularly preferably greater than 1000 HV. The hardness of first armature lining 41 is, in particular, less than 200 HV and the hardness of second armature lining 42 is greater than 1000 HV.

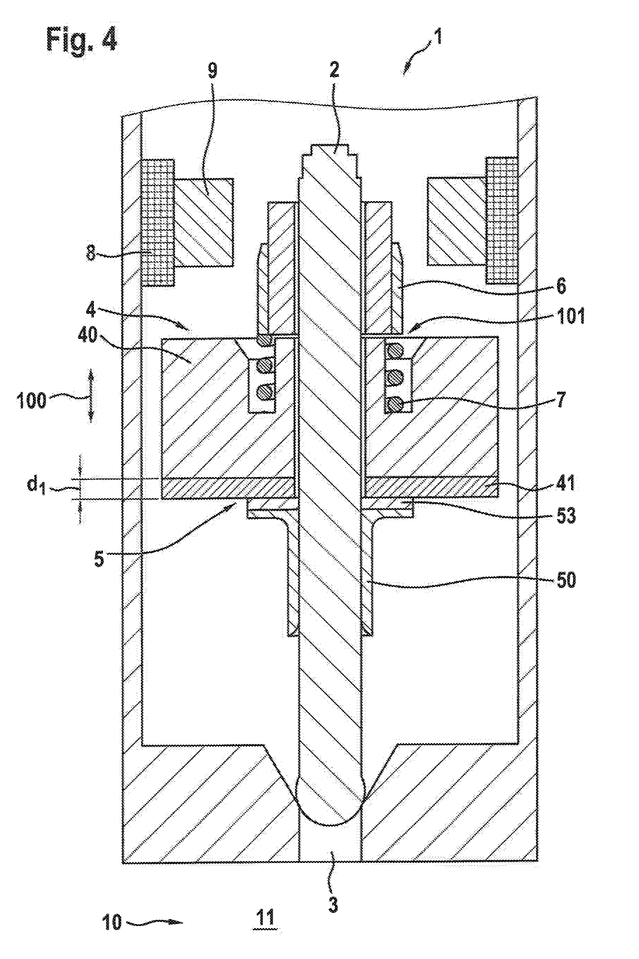

FIG. 4 shows a solenoid valve 1 for controlling fluids according to a third exemplary embodiment of the present invention.

In addition to first armature lining 41 on armature base body 40 as in the first exemplary embodiment, here a stop lining 53 is situated directly on stop base body 50. Stop lining 53 in this case exhibits a greater hardness than first armature lining 41. Armature 4 and armature stop 5 are contactable to one another via first armature lining 41 and stop lining 53. First armature lining 41 and stop lining 53 are situated opposite one another.

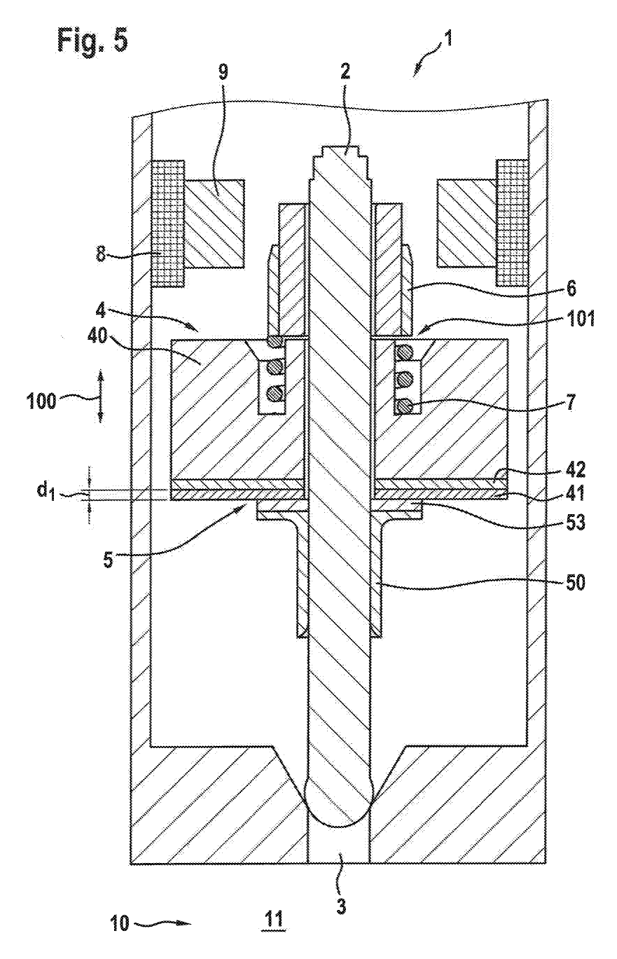

FIG. 5 shows a solenoid valve 1 for controlling fluids according to a fourth exemplary embodiment of the present invention.

Here, as in the second exemplary embodiment, two armature linings are provided, namely first armature lining 41 and second armature lining 42. In addition, stop lining 53 is situated on stop base body 50 as in the third exemplary embodiment.

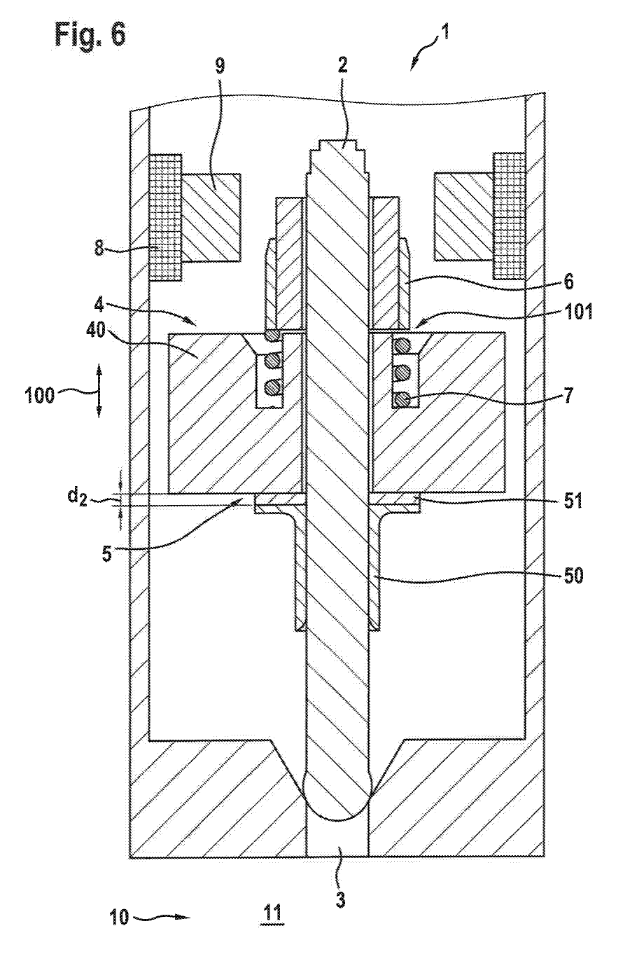

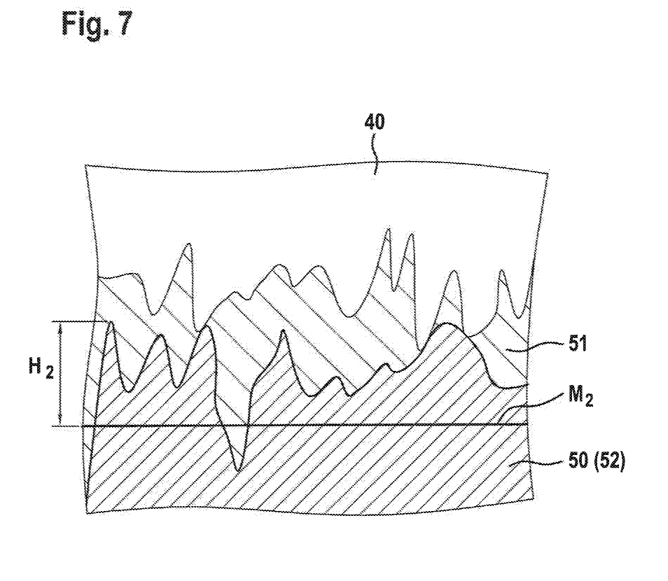

A solenoid valve 1 for controlling fluids according to a fifth exemplary embodiment of the present invention is described below with reference to FIGS. 6 and 7.

Armature stop 5 includes a stop base body 50 having a first stop lining 51, which is situated directly on stop base body 50 and has a lower hardness than armature 4 or armature base body 40. In this case, no lining is provided on armature 4.

In addition, a thickness d2 (FIG. 6) of first stop lining 51 is less than 80% of a height H2 of a maximum roughness peak of stop base body 50, height H2 of the maximum roughness peak being measured from a center line M2 of a roughness profile of stop base body 50 (FIG. 7).

In addition a hardness of first stop lining 51 is less than 100 HV, preferably less than 150 HV, particularly preferably less than 200 HV.

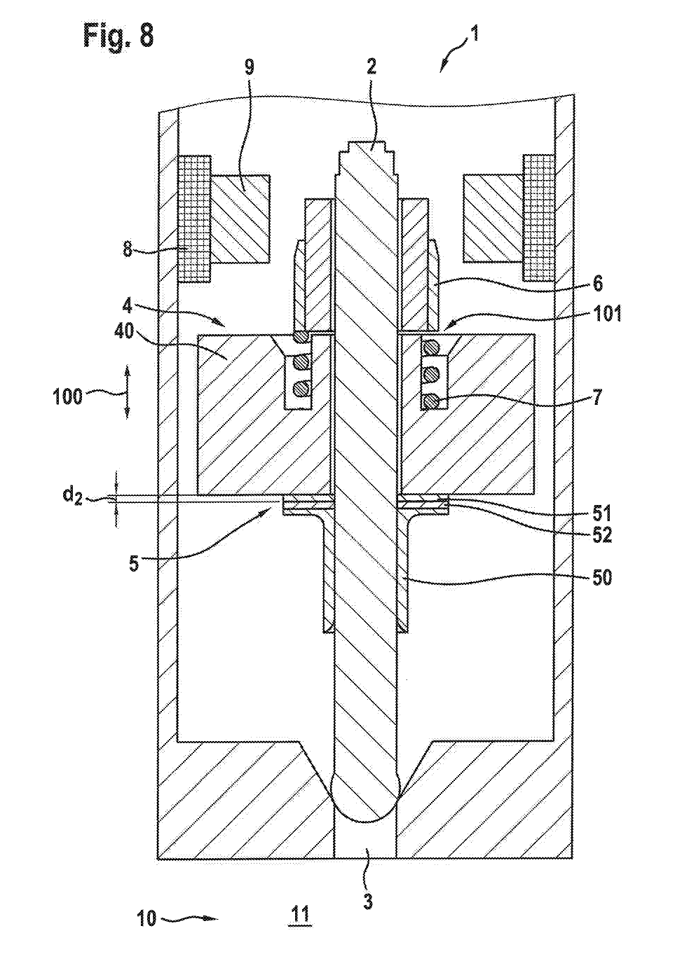

FIG. 8 shows a solenoid valve 1 according to a sixth exemplary embodiment of the present invention.

Here, stop body 5 further includes a second stop lining 52, which is situated between stop base body 50 and first stop lining 51. Second stop lining 52 exhibits a greater hardness than first stop lining 51.

Thickness d3 (FIG. 8) of first stop lining 51 is less than 80% of a height H2 of a maximum roughness peak of second stop lining 52, height H2 of the maximum roughness peak being measured from a center line M2 of a roughness profile of second stop lining 52 (reference numeral 52 placed in parentheses in FIG. 7).

In addition, a hardness of first stop lining 51 is less than 100 HV, preferably less than 150 HV, particularly preferably less than 200 HV and/or a hardness of second stop lining 52 is greater than 800 HV, preferably greater than 900 HV, particular preferably greater than 1000 HV. The hardness of first stop lining 51 is, in particular, less than 200 HV and the hardness of second stop lining 52 is greater than 1000 HV.

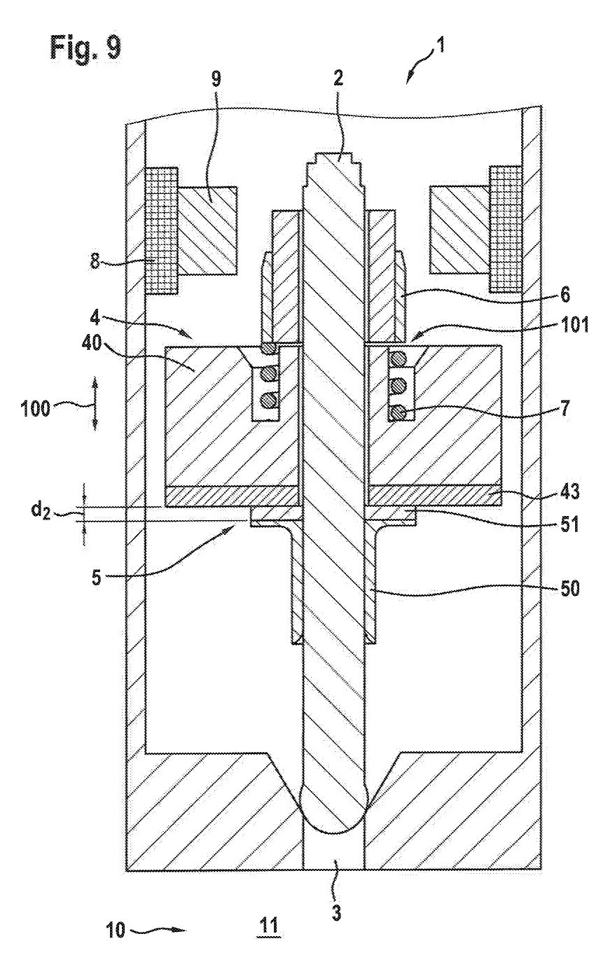

FIG. 9 shows a solenoid valve 1 according to a seventh exemplary embodiment of the present invention.

Here, in addition to first stop lining 51 on stop basis body 50, an armature lining 43 is situated directly on armature base body 40. Armature lining 43 in this case exhibits a greater hardness than first stop lining 51.

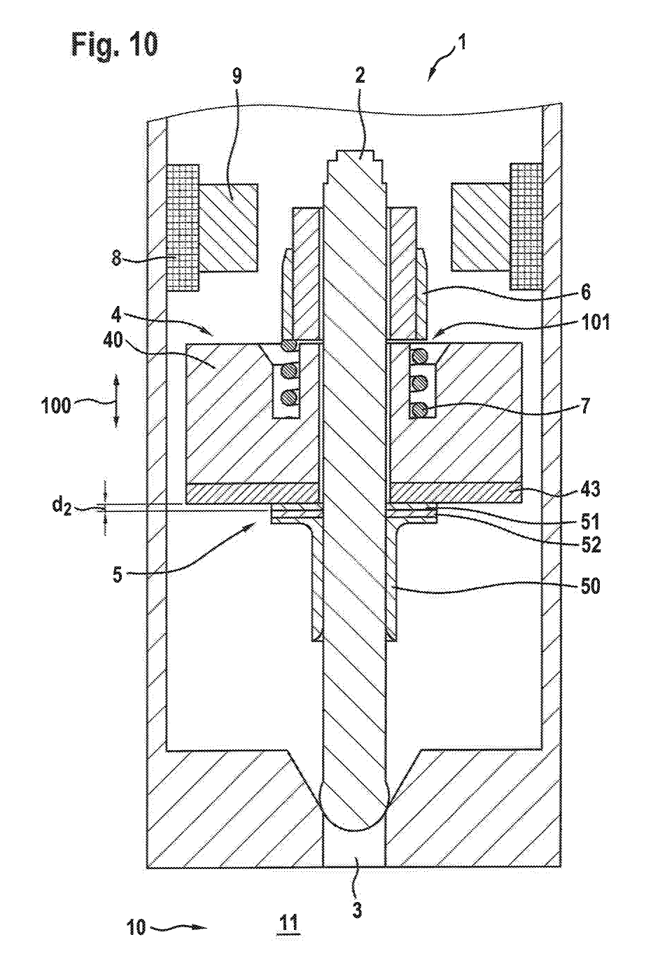

FIG. 10 shows a solenoid valve 1 according to an eighth exemplary embodiment of the present invention.

Here, two stop linings are provided, namely first stop lining 51 and second stop lining 52, second stop lining 52 being situated between first stop lining 51 and stop base body 50. Furthermore, armature lining 43 is mounted directly on armature base body 40.

In general, a solenoid valve is provided by the present invention, including a first component (armature or armature stop) and a second component (armature stop or armature), which are contactable with one another, the hardnesses of their surfaces contacting one another being different. This is achieved by providing a layer or lining on one of the components, which is softer than the opposing surface of the other component. With this structure, the surfaces contacting one another rapidly align with one another within the first thousand load changes, which results in excellent damping properties.

It is noted that the present invention has been explained with the aid of an inwardly opening valve. However, solenoid valve 1 may also be designed as an outwardly opening valve. In this case, the above described specific embodiments relate to additional armature stop 6 instead of armature stop 5 in terms of the stop linings and, in terms of the armature linings, if present, to the surface of armature 4 facing additional stop 6.

What is claimed is:

1. A solenoid valve for controlling fluids, the solenoid valve being a fuel injection solenoid valve, the solenoid valve comprising:
a valve member for opening and closing an opening;
an armature for actuating the valve member; and
an armature stop via which a movement of the armature is delimitable;
wherein to dampen a movement of the armature, one of:
(i) the armature includes an armature base body having a first armature lining, which is situated on the armature base body and which exhibits a lower hardness than the armature stop, or
(ii) the armature stop includes a stop base body having a first stop lining, which is situated on the stop base body and which exhibits a lower hardness than the armature.

2. The solenoid valve as recited in claim 1, wherein one of: (i) a second armature lining, which exhibits a greater hardness than the first armature lining, is situated on the armature between the armature base body and the first armature lining, or (ii) a second stop lining, which exhibits a greater hardness than the first stop lining, is situated on the armature stop between the stop base body and the first stop lining.

3. The solenoid valve as recited in claim 1, wherein one of: (i) the armature stop includes a stop base body having a stop lining, which exhibits a greater hardness than the first armature lining, or (ii) the armature includes an armature base body having an armature lining which exhibits a greater hardness than the first stop lining.

4. The solenoid valve as recited in claim 1, wherein the first armature lining or the first stop lining is metallic.

5. The solenoid valve as recited in claim 1, wherein one of: (i) a thickness of the first armature lining is less than 80% of a height of a maximum roughness peak of the second armature lining or of the armature base body, the height of the maximum roughness peak being measured from a center line of a roughness profile of the second armature lining or of the armature base body, or (ii) a thickness of the first stop lining is less than 80% of a height of a maximum roughness peak of the second stop lining or of the stop base body, the height of the maximum roughness peak being measured from a center line of a roughness profile of the second stop lining or of the stop base body.

6. The solenoid valve as recited in claim 1, wherein an additional, separate damping device is provided, which is configured to dampen the movement of the armature.

7. The solenoid valve as recited in claim 1, wherein one of: (i) a hardness of the first armature lining is less than 100 HV, and/or a harness of the second armature lining is greater than 800 HV, or (ii) a hardness of the first stop lining is less than 100 HV and/or a hardness of the second stop lining (52) being greater than 800 HV.

8. The solenoid valve as recited in claim 1, wherein a hardness of the first armature lining is less than 150 HV.

9. The solenoid valve as recited in claim 1, wherein a hardness of the first armature lining is less than 200 HV.

10. The solenoid valve as recited in claim 1, wherein a hardness of the second armature lining is greater than 900 HV.

11. The solenoid valve as recited in claim 1, wherein a hardness of the second armature lining is greater than 1000 HV.

12. The solenoid valve as recited in claim 1, wherein a hardness of the first stop lining is less than 150 HV.

13. The solenoid valve as recited in claim 1, wherein a hardness of the first stop lining is less than 200 HV.

14. The solenoid valve as recited in claim 1, wherein a hardness of the second stop lining is greater than 900 HV.

15. The solenoid valve as recited in claim 1, wherein a hardness of the second stop lining is greater than 1000 HV.

16. An internal combustion engine, including a solenoid valve, the solenoid valve being a fuel injection solenoid valve, the solenoid valve comprising:
a valve member for opening and closing an opening;
an armature for actuating the valve member; and
an armature stop via which a movement of the armature is delimitable;
wherein to dampen a movement of the armature, one of:
(i) the armature includes an armature base body having a first armature lining, which is situated on the armature base body and which exhibits a lower hardness than the armature stop, or
(ii) the armature stop includes a stop base body having a first stop lining, which is situated on the stop base body and which exhibits a lower hardness than the armature.

17. A vehicle, including an internal combustion engine having a solenoid valve, the solenoid valve being a fuel injection solenoid valve, the solenoid valve comprising:
a valve member for opening and closing an opening;
an armature for actuating the valve member; and
an armature stop via which a movement of the armature is delimitable;
wherein to dampen a movement of the armature, one of:
(i) the armature includes an armature base body having a first armature lining, which is situated on the armature base body and which exhibits a lower hardness than the armature stop, or
(ii) the armature stop includes a stop base body having a first stop lining, which is situated on the stop base body and which exhibits a lower hardness than the armature.
